(19) United States
(12) Patent Application Publication
(10) Pub. No.: US 2018/0279418 A1
(43) Pub. Date: Sep. 27, 2018

(54) High Voltage Skin Effect Heater Cable with Ribbed Semiconductive Jacket

(71) Applicant: Pentair Flow Services AG, Schaffhausen (CH)

(72) Inventors: Wesley Dong, Belmont, CA (US); Paul Becker, San Carlos, CA (US); David Parman, San Ramon, CA (US)

(21) Appl. No.: 15/933,203

(22) Filed: Mar. 22, 2018

Related U.S. Application Data
(60) Provisional application No. 62/475,113, filed on Mar. 22, 2017.

(51) Int. Cl. H05B 3/56; H01B 7/02

(52) U.S. Cl. CPC H05B 3/56; H05B 2203/021; H01B 7/02

(57) ABSTRACT

A heater cable for use in a heat tube. The heater cable includes a core conductor, an electrical insulation layer surrounding the core conductor, and an outer semiconductive layer surrounding the electrical insulation layer. The outer semiconductive layer is exposed so that, when installed in the heat tube, the outer semiconductive layer is in physical and electrical contact with an inner diameter of the heat tube. The outer semiconductive layer, or jacket, has ribs or similar spacing structures that contact the inner surface of the heat tube and space the components of the heater cable away from the inner surface of the heat tube and toward the center of the heat tube to reduce or eliminate the incidence of partial discharge.

### CROSS-REFERENCE TO RELATED APPLICATIONS

This application is a non-provisional claiming the benefit of priority from U.S. Prov. Pat. App. Ser. No. 62/475,113, entitled “HIGH VOLTAGE SKIN EFFECT HEATER CABLE WITH RIBBED SEMICONDUCTIVE JACKET,” filed Mar. 22, 2017, and incorporated in its entirety herein by reference.

### BACKGROUND

In the oil and gas industry, pipelines must be heated over distances of many miles. Skin effect electric heat tracing systems are ideally suited for long transfer pipelines up to 12 miles (20 km) per circuit. The system is engineered for the specific application, non-limiting examples of which include material transfer lines, snow melting and de-icing, tank foundation heating, subsea transfer lines and prefabricated, pre-insulated lines. In a skin-effect heating system, heat is generated on the inner surface of a ferromagnetic heat tube that is thermally coupled to the pipe to be heat traced. An electrically insulated, temperature-resistant conductor is installed inside the heat tube and connected to the tube at the far end. An alternating current (AC) is passed through the insulated conductor and returns through the heat tube.

In a traditional skin effect heating system, the core conductor of the heater cable sits inside an insulation layer. The heater cable is surrounded by air except at the point at which the insulating jacket contacts the inner surface of the heat tube. Partial discharge is caused by the charge differential between the surface of the insulation and the inner surface of the grounded heat tube, which carries the return AC in the opposite direction; the inner surface of the heat tube has the highest charge density, relative to the rest of the heat tube, due to the skin effect. Protracted partial discharge can erode solid insulation and eventually lead to breakdown of insulation at the point of contact. Protracted partial discharge also tends to initiate at defects (voids, imperfections, contaminants) in the insulation layer. It can also cause a corona effect, a localized discharge resulting from transient gaseous ionization on an insulation system when the voltage stress exceeds a critical value; inception in air at room temperature occurs at or about 3×10⁶ V/m. An insulating material can have a maximum desirable amount of partial discharge: protracted partial discharge at or below this threshold may not be harmful to the material or the surroundings, but beyond the maximum, partial discharge begins to damage the material. The material can further have a maximum recommended operating voltage at which partial discharge from the material does not exceed the maximum desirable amount.

The ferromagnetic heat tube of a skin-effect heating system is prone to the corona effect as a charge difference builds up between the surface of the tube and the surface of the insulated conductor and exceeds the breakdown electric field for air (3×10⁶ V/m). This effect becomes a significant issue for longer pipelines that require a higher voltage potential to drive the current that also results in greater charge build up between the two surfaces. Partial discharge of the accumulated static electricity can damage or prematurely age the insulation and other components, and at high voltages (relative to rated voltages of the component materials) can discharge in arcing events. Thus, industry standards have developed to limit partial discharge at or below a desired level. Heater cable component materials, particularly electrical insulation materials, are characterized by a rated voltage at which partial discharge from the material does not exceed 10 picoCoulombs. Notably, some materials can tolerate much more than 10 picoCoulombs (e.g., Silicone, at about 20 nanoCoulombs), but must operate at the rated voltage in the field.

The rated voltages of materials used in the heater cables must therefore be considered in conjunction with other material advantages. For example, perfluoroalkoxy polymer (PFA) is an ideal electrical insulating material for higher temperature applications, such as sulfur transfer lines where the operating cable temperatures are around 135-140 degC. PFA insulation is rated to 265 C and enables running at higher current densities than with lower temperature insulations such as high-density polyethylene (HDPE), ethylene propylene diene monomer (EPDM) rubber ethylene propylene rubber (EPR), and silicone. However, the rated voltage of unshielded PFA cable is about 2.5 kV or 3 kV, and requires circuit lengths, and therefore also cable lengths, to be shorter than those using materials with higher rated voltages (e.g., Silicone at 5 kV) but lower operating temperatures.

### SUMMARY

The described invention includes a system to heat long pipelines (for example, on the order of 36 miles) and to handle voltages in excess of the rated voltage associated with the electrical insulation material used in the heater cable, at acceptably low levels of partial discharge.

Some embodiments of the invention provide a skin effect heating system including a ferromagnetic heat tube that applies heat to a carrier pipe, and a heater cable disposed in an interior of the heat tube. The heater cable includes: a conductor; an inner semiconductive layer surrounding the conductor, an electrical insulation layer surrounding the inner semiconductive layer, and an outer semiconductive layer surrounding and shielding the electrical insulation. The outer semiconductive layer includes a base layer physically contacting the electrical insulation, and a plurality of ribs integral with, and extending radially outwardly from, the base layer, one or more of the plurality of ribs being in physical and electrical contact with an inner surface of the heat tube and spacing the conductor and the base layer away from the inner surface and toward a center of the heat tube. The plurality of ribs can extend longitudinally along an entire length of the heater cable. The plurality of ribs can be uniformly spaced laterally around the heater cable. A first rib and a second rib, each physically contacting the inner surface of the heat tube, can produce an air gap defined by intersecting surfaces of the first rib, the base layer, the second rib, and the heat tube.

The electrical insulation layer can be associated with an incidence of partial discharge that, when the electrical insulation layer is unshielded and is subjected to a voltage greater than a first rated voltage, exceeds a desirable maximum amount of partial discharge; the electrical insulation layer can have a first resistivity and the outer semiconductive layer can have a second resistivity that cooperate to enable the heater cable to, in response to an alternating current being applied to the conductor at an applied voltage exceeding the first rated voltage: maintain an amount of partial discharge of the heater cable at or below the desirable maximum amount of partial discharge, and allow no more than an insignificant portion of a return electric current flowing on the inner surface of the heat tube in opposite direction to the alternating current of the conductor to be diverted to the outer semiconductive layer, such that the loss by the heat tube of the insignificant portion does not affect heat output of the heat tube.

Some embodiments of the invention provide a heater cable for use in a ferromagnetic heat tube (i.e., to form an electric circuit that operates by skin effect). The heater cable includes: a core conductor that electrically connects at a first end to a source of alternating current, and at a second end to the heat tube; an electrical insulation layer surrounding the core conductor; and, a semiconductive outer jacket layer surrounding the electrical insulation layer and including a base layer and a plurality of ribs extending radially outwardly from the base layer, the outer jacket layer exposed so that, when the heater cable is installed in the heat tube, one or more of the plurality of ribs physically contact an inner surface of the heat tube and space the core conductor away from the inner surface and toward a center of the heat tube. The ribs can extend longitudinally along an entire length of the heater cable, and/or can be uniformly spaced laterally around the heater cable. The ribs that physically contact the inner surface of the heat tube can produce an air gap between an outer surface of the base layer and the inner surface of the heat tube.

The base layer and the plurality of ribs can be composed of one or more semiconductive materials. The plurality of ribs can be integral with the base layer. The outer jacket layer can be extruded over the electrical insulation layer, the base layer being in physical contact with the electrical insulation layer around an entire circumference of the electrical insulation layer. The heater cable can further include an inner semiconductive layer surrounding the core conductor and surrounded by the electrical insulation layer, the inner semiconductive layer physically contacting the electrical insulation layer around an entire circumference of the inner semiconductive layer. When the heater cable is installed in the heat tube, the heater cable can physically contact the inner surface of the heat tube only at a first small area of a first rib and a second small area of a second rib adjacent to the first rib.

The electrical insulation layer can be associated with an incidence of partial discharge that, when the electrical insulation layer is unshielded and is subjected to a voltage greater than a first rated voltage, exceeds a desirable maximum amount of partial discharge. The outer jacket layer can shield the electrical insulation layer, and can have a resistivity that enables the heater cable to, in response to an alternating current being applied to the conductor at an applied voltage exceeding the first rated voltage: maintain an amount of partial discharge of the heater cable at or below the desirable maximum amount of partial discharge; and, allow no more than an insignificant portion of a return electric current flowing on the inner surface of the heat tube in opposite direction to the alternating current of the conductor to be diverted to the outer jacket layer, such that the loss by the heat tube of the insignificant portion does not affect heat output of the heat tube. The electrical insulation layer can be perfluoroalkoxy polymer (PFA) with a rated voltage of about 3000 volts; the applied voltage can be between 3500 and 7500 volts, inclusive. The outer jacket layer can be conductive PFA extruded onto the electrical insulation layer. The resistivity of the outer jacket layer can be between 5 and 1000 ohm-cm inclusive. Or, the electrical insulation layer can be silicone with a rated voltage of about 5000 volts, and the applied voltage can be at least 10,000 volts; the resistivity of the outer jacket layer can be between 0.1 and 10⁵ ohm-cm inclusive.

The foregoing and other aspects and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims and herein for interpreting the scope of the invention.

### DESCRIPTION OF THE DRAWINGS

FIG. 1 is a cross-sectional view of a typical heater cable in a heat tube of a skin effect heat tracing system.

FIG. 2 is a perspective view of a skin effect heat tracing system.

FIG. 3 is a cross-sectional view of a heater cable, according to one embodiment of the disclosure, in a heat tube.

FIG. 4 is a perspective cross-sectional view of a heater cable according to another embodiment of the disclosure.

FIG. 4A is a perspective cross-sectional view of the heater cable of FIG. 4 without its conductive core.

FIG. 5 is a cross-sectional view of the heater cable of FIG. 4 without its conductive core.

### DETAILED DESCRIPTION

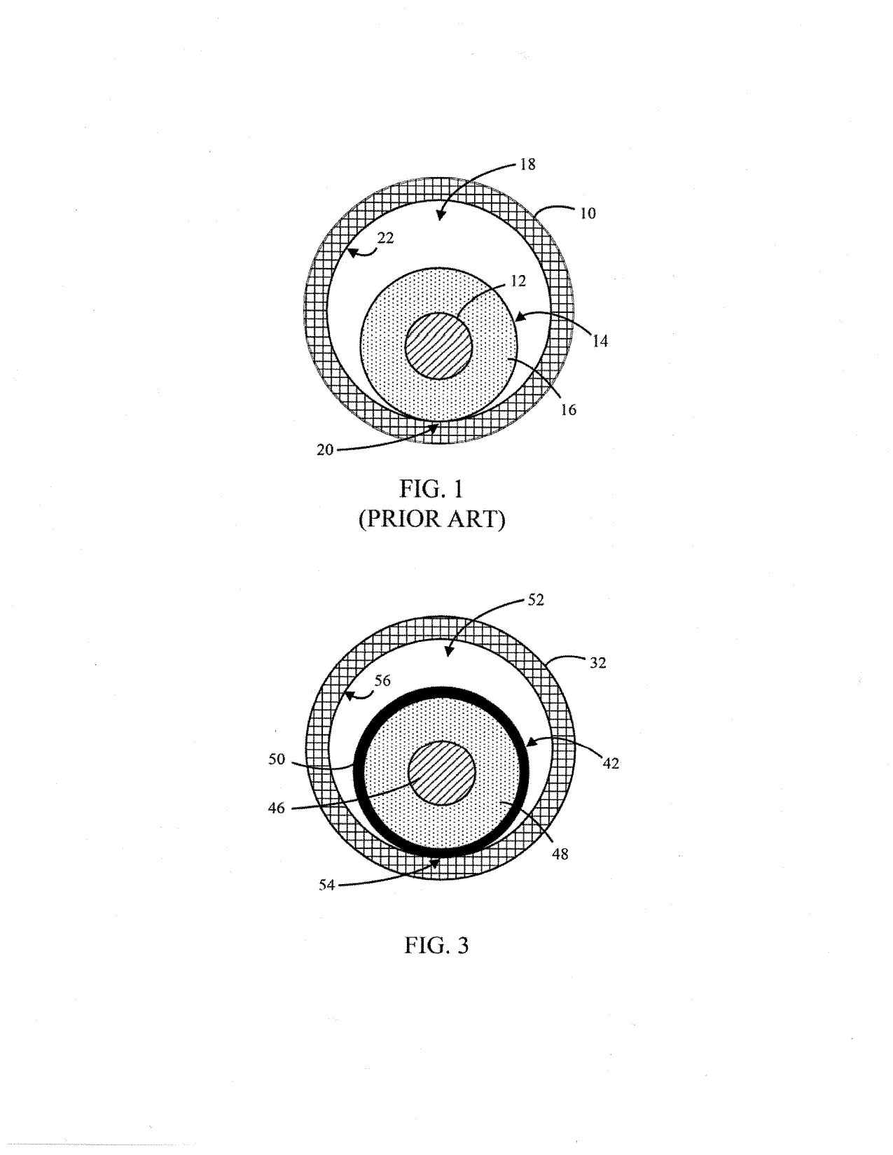

As shown in FIG. 1, in a traditional heat tube 10, the core conductor 12 of a heater cable 14 sits inside an insulation layer 16. The heater cable 14 is surrounded by air 18 except at a point 20 at which it lies in contact with the inner surface 22 of the heat tube 10. Partial discharge can occur throughout the heater cable 14, but particularly occurs approximate the point 20 due to the charge differential between the surface of the insulation 16 and the inner surface 22 of the grounded heat tube 10. Protracted partial discharge can erode solid insulation 16 and eventually lead to breakdown of insulation 16 at the point of contact 20. Protracted partial discharge also tends to initiate defects (voids, imperfections, contaminants) in the heat tube 10.

FIG. 2 illustrates a skin-effect heating system 30. A ferromagnetic heat tube 32, such as a carbon steel tube, is placed against a carrier pipe 34 used for transporting oil, gas, or other heavy fluids. A heater cable lies inside the heat tube 32. A transformer 36 and a control box 38 are in electrical communication with the heat tube 32 at electrical connection boxes 40. These connection boxes 40 allow individual sections or circuits of the heat cable to be modified, replaced, or serviced without disturbing the insulation. Circuit lengths are determined by a combination of cable size, cable voltage, temperature or voltage rating, heat tube size, and attachment method. Ratings such as operating temperature or voltage can depend on the materials used in the heat tube 32 and the heater cable. For example, it is currently feasible to heat circuit lengths up to 25 Kilometers (15 miles) from a single source using supply voltages approaching 5,000 volts when the heater cable has an electrical insulation layer made of silicone. Approximately the same circuit length can be achieved with an electrical insulation layer made of perfluoroalkoxy (PFA) polymer when the supply voltage is about 2500 volts to 3000 volts. For purposes of this description, these industry-standard operating voltages, which can vary based on heating system composition but generally relate to the type of electrical insulation material used, are referred to as “rated voltages.”

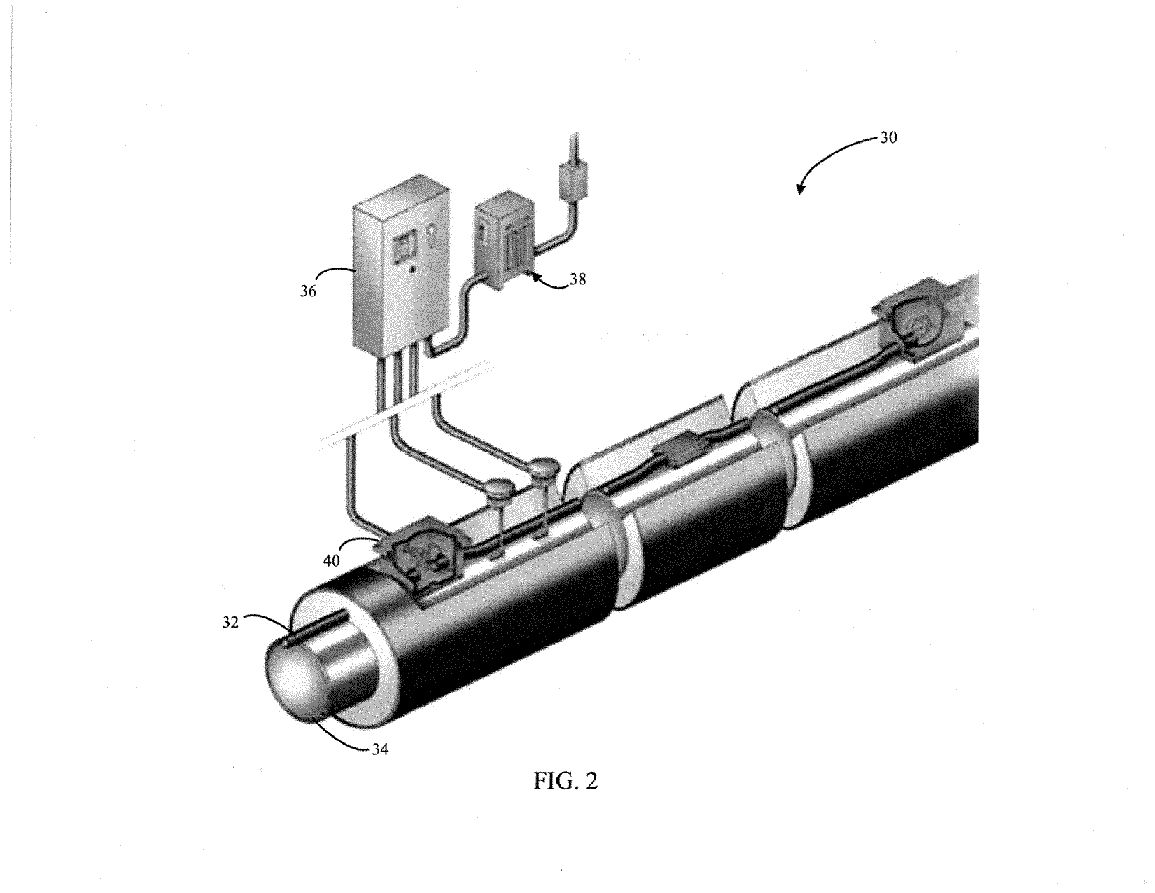

The invention, however, provides a skin effect trace heating system that can operate well above the rated voltage while maintaining partial discharge at or below a desired level, usually measured in nano- or picocoulombs. For example, a skin effect heating system as described herein, using silicone as the electrical insulation material of the heater cable, can operate at over 5 kV, such as at 7.5 kV, 10 kV, 14 kV, or higher, and partial discharge of the heater cable does not exceed 20 nanocoulombs and further may not exceed one nanocoulomb. In another example, a skin effect heating system as described herein, using PFA as the electrical insulation material of the beater cable, can operate at over 3 kV, such as at 3.5 kV, 5 kV, 7.5 kV, or higher, and partial discharge of the heater cable does not exceed one nanocoulomb and further may not exceed 10 picocoulombs. In particular, FIGS. 3-5 illustrate heater cables 42, 44 in accordance with various embodiments. The heater cables 42, 44 are configured to be installed inside a heat tube (such as the heat tube 32 shown in FIG. 2) to heat an inner surface of the heat tube. As further described below, the heater cables 42, 44 are configured to ensure a more uniform electric field to minimize corona effects by including one or more semiconductive jacket layers and, in some embodiments, providing an outer semiconductive jacket layer with features that space the heater cable away from a local ground plane (i.e., the interior of the heat tube).

Referring to FIG. 3, the heater cable 42 includes a conductor 46 at its core, an optional inner jacket layer (not shown), an insulation layer 48, and an outer jacket layer 50. The conductor 46 can include any suitable conductive material such as tinned copper, nickel plated copper, aluminum, steel, gold, platinum, silver, and others. The conductor 46 may be a solid conductor wire or may be stranded wire. The conductor 46 is encapsulated within the non-conducting electrical insulation layer 48. The electrical insulation layer 48 may include any suitable material such as silicone, PFA, ethylene propylene diene monomer (EPDM) rubber, ethylene propylene rubber (EPR), cross-linked polyethylene (XPLE), and others. In some embodiments, the circumference of the conductor 46 is entirely in physical contact with the electrical insulation layer 48.

In other embodiments, the conductor 46 is encapsulated in or in direct electrical contact with the inner jacket layer, which comprises a semiconductive material. In such embodiments, the inner jacket layer is encapsulated within the electrical insulation layer 48 and further may separate the conductor 46 from the electrical insulation layer 48. The inner jacket layer of semiconductive material may be entirely in contact with the electrical insulation layer 48 and entirely or substantially in contact with the conductor 46. In some embodiments, a stranded conductor 46 may cause air pockets to form between the strands during the manufacturing process. If these air pockets are formed between the conductor 46 and the electrical insulation layer 48, they can be a source of corona partial discharge as a charge accumulates on the outer surface of the conductor 46. The semiconductive inner jacket layer may serve to neutralize or “short out” any air pockets formed at the outer surface of the conductor 46, preventing partial discharge by providing an additional conductive path to dissipate the accumulating charge and keeping a smooth interface, which provides for a smooth electric field gradient, at the semiconductor/insulation boundary. In some embodiments, the heater cable can further include a stripping layer (not shown) disposed between the conductor 46 and the inner jacket layer. The stripping layer facilitates clean stripping of the conductor 46—that is, no residue of the inner jacket layer nor of the stripping layer is left on the conductor 46—which aids in preparing the conductor 46 for attachment to a terminal, a barrel crimp, another conductor, etc. The stripping layer may be conductive, or may be non-conductive and still allow electrical contact to be maintained between the conductor 46 and the semiconductive inner jacket layer.

A semiconductive outer jacket layer 50 surrounds the electrical insulation layer 48. As shown in FIG. 3, the outer jacket layer 50 can be exposed—that is, the outer jacket layer 50 is not covered by any additional layers.

The outer jacket layer 50 can, in some embodiments, be made of the same base material as the insulation 48 (e.g., silicone, PFA, etc.) but loaded with carbon black or other conductive material. In particular, and as further described herein, the composition of the outer jacket layer 50 can be selected so that the outer jacket layer 50, which contacts the inner surface of the heat tube being heated, reduces or eliminates corona partial discharge without interfering with the electrical relationship between the heater cable 42 and the heat tube that enables skin effect heating. Thus, the resistivity of the material comprising the outer jacket layer 50 may be low enough to reduce or eliminate corona at the outer surface of the heater cable 42. In particular, the resistivity may be low enough to prevent corona discharge even at locations along the length of the heater cable 42 where the heater cable 42 is not continuously in contact with the cooperating heat tube. Furthermore, the resistivity of the outer jacket layer 50 may be high enough that the return alternating current, flowing along the inner surface of a cooperating heat tube (e.g., heat tube 32 of FIG. 3) in the opposite direction to alternating current in the conductor 46, does not flow substantially into the outer jacket layer 50. In particular, it is understood that the heat tube's 32 transmission of the return skin effect current may contribute more than half (typically about 70%) of the thermal energy in the skin effect trace heating system (the heater cable 42 contributes the remainder of the thermal energy); the outer jacket layer 50 may have a resistivity that only allows, at most, an insignificant portion of the return current to flow into or through the outer jacket layer 50, so that skin effect heating of the heat tube is not disrupted. For example, the outer jacket layer 50 may divert less than about 1% of the return current from the inner surface of the heat tube. In some embodiments, the outer jacket layer 50 may have a bulk, or volume, resistivity between 0.1 ohm-cm and 1×10⁸ ohm-cm. For example, in one embodiment, the outer jacket layer 50 has a bulk resistivity around 1000 ohm-cm. In other embodiments, the outer jacket layer 50 has a bulk resistivity between about 10 ohm-cm to 199 ohm-cm, or between about 10² ohm-cm to 10⁶ ohm-cm, or between about 10³ ohm-cm to 10⁵ ohm-cm. The outer jacket layer 50 may be applied to the insulation layer 48 by a standard extrusion and/or co-extrusion process, or by other methods, such as wrapping a length of semiconductive tape around the insulation layer 48 to form the outer jacket layer 50.

Generally, when installed in a heat tube 32, as shown in FIG. 3, the heater cable 42 is surrounded by air 52 except at a point 54 at which it lies in contact with the inner diameter 56 of the heat tube 32. In typical installations, as shown in FIG. 1, an insulated wire 14 rests in contact with an interior 22 of a heat tube 10. This eccentric geometry of typical installations produces non-uniform electrical fields with the highest electric field being where the wire 14 contacts the heat tube 10 (i.e., at a point 20). Electric charge accumulates on the surface of the insulation 16 and discharges as corona (partial discharge). However, in embodiments such as that shown in FIG. 3, the outer jacket layer 50 is in physical and electrical contact with the interior 56 of the heat tube 32. As a result, electric charge can be dissipated through the outer jacket layer 50, effectively reducing or eliminating corona and its ill effects.

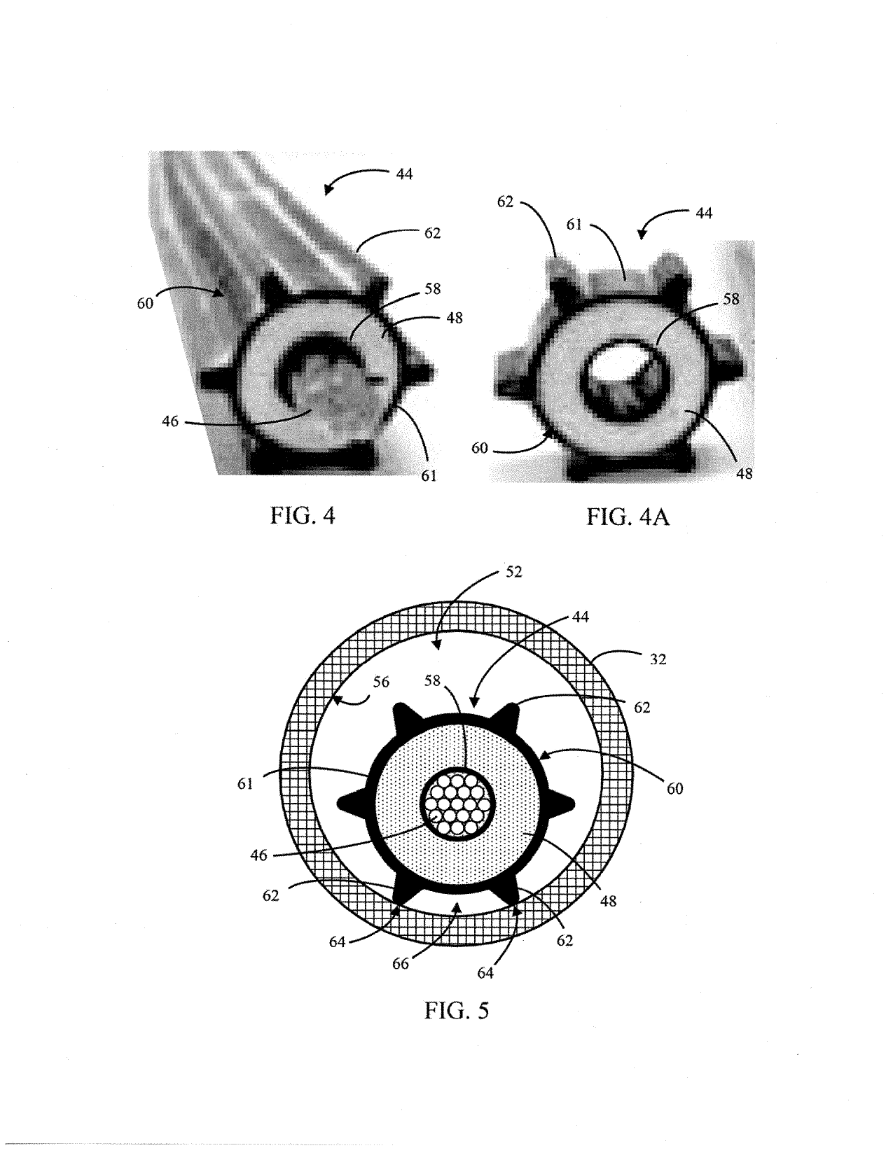

FIGS. 4-5 illustrate a heater cable 44 including a stranded conductor 46 at its core, an inner jacket layer 58, an insulation layer 48, and an outer jacket layer 60. The components of the heater cable 44 can be similar to those described above with respect to the heater cable 42 of FIG. 3, except that the outer jacket layer 60 can further include spacing structures, such as ribs 62, which extend radially outwardly from a base layer 61 of the outer jacket layer 60. The base layer 61 can be a tubular structure contacting the electrical insulation layer 48 around some or all of the circumference of the electrical insulation layer 48, as described above and illustrated with respect to the outer jacket layer 50. The ribs 62, which can be integral with or attached to the base layer 61, act as spacers to increase a distance from the conductor 46 and/or base layer to a ground plane (i.e., the inside surface 56 of a heat tube 32). Increasing the distance between the heat tube 32 and the conductor 46 can make electric fields more uniform and less stressful on the heater cable 44. Further, the ribs 62 can be designed so that, when in contact with the inner surface 56 of the heat tube 32, adjacent ribs 62 produce one or more air gaps 66 between the base layer 61 and the heat tube 32. For example, the illustrated air gap is defined by intersecting outer/inner surfaces of a first rib 62, the base layer 61, a second rib 62 adjacent to the first rib 62, and the heat tube 32. Such air gaps 66 can further make the electric fields more uniform, and provide other structural advantages that reduce partial discharge. In particular, with the geometry of one embodiment of the present invention, shown in FIGS. 4 and 4A, partial discharge only occurs on two small areas 64 of two ribs 62 (i.e., the two areas 64 that make both physical and electrical contact with the inner surface 56 of the heat tube 32), and not on the insulation surface 48.

In the embodiment of FIGS. 4-5, six ribs 62 or “spokes” are shown. Other numbers of spokes 62, from 3 or more, are also feasible. It is likely that 5-8 spokes 62 is optimum for separating the cable 44 from the ground plane, and to maintain good flexibility of the cable 44. As for the thickness of the ribs 62 relative to the core insulation 48, the rib thickness may be any nonzero value larger than the core thickness and equal or less than the inner diameter of the heat tube 32. In various embodiments that minimize or eliminate both corona discharge and heat loss, the ribbed outer jacket layer 60 may have a bulk, or volume, resistivity between 0.1 ohm-cm and 1×10⁹ ohm-cm. For example, in one embodiment, the outer jacket layer 60 has a bulk resistivity around 1000 ohm-cm. In other embodiments, the outer jacket layer 60 has a bulk resistivity between about 10 ohm-cm to 199 ohm-cm, or between about 10² ohm-cm to 10⁶ ohm-cm, or between about 10³ ohm-cm to 10⁵ ohm-cm. In another example embodiment, the heater cable 44 is intended to operate above 150 degC (i.e., the conductor 46 is capable of carrying a current that the cable 44 converts into thermal energy that heats the cable 44 to over 150 degC); the electrical insulation layer 48 is PFA, and the heater cable 44 is intended to operate at about 3500V-7500V within a carbon steel heat tube at up to 260 degC, the outer jacket layer 60 can be an extrudable conductive PFA having a bulk resistivity of about 5-1000 ohm-cm.

Accordingly, the electrical connecting and/or spacing of the heater cables 42, 44 from the heater tube 32, as described above, improves their application to pipeline systems. More specifically, the present disclosure reduces electrical fields in air (and partial discharge thereby) on a heater cable located in a grounded electrically conductive tube in a quantifiable fashion. The heater cables of the present disclosure provide a conductive path for charge build up in the insulation to transfer out to the tube (ground) through the semiconductive jacket layers (that is, because there is no outer insulation layer applied over the outer jacket layer). Since charge accumulation is eliminated or mitigated using the present invention, higher voltages can be applied to the heater cable. Consequently, a skin-effect heating system using embodiments of the present disclosure can include a heat tube deployed with longer distances between line lead connections compared to typical systems. For example, heater cables of the present disclosure were tested at up to 14 kV (with a silicone electrical insulation layer) and showed a reduction in partial discharge of 200 to 300 times as compared to typical non-semiconductive jacketed heater cables.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A skin effect heating system comprising:
a ferromagnetic heat tube that applies heat to a carrier pipe; and
a heater cable disposed in an interior of the heat tube, the heater cable comprising:
a conductor;
an inner semiconductive layer surrounding the conductor;
an electrical insulation layer surrounding the inner semiconductive layer; and
an outer semiconductive layer surrounding and shielding the electrical insulation, the outer semiconductive layer comprising:
a base layer physically contacting the electrical insulation; and
a plurality of ribs integral with, and extending radially outwardly from, the base layer, one or more of the plurality of ribs being in physical and electrical contact with an inner surface of the heat tube and spacing the conductor and the base layer away from the inner surface and toward a center of the heat tube.

2. The skin effect heating system of claim 1, wherein the electrical insulation layer is associated with an incidence of partial discharge that, when the electrical insulation layer is unshielded and is subjected to a voltage greater than a first rated voltage, exceeds a desirable maximum amount of partial discharge, and the electrical insulation layer has a first resistivity and the outer semiconductive layer has a second resistivity that enables the heater cable to, in response to an alternating current being applied to the conductor at an applied voltage exceeding the first rated voltage:
maintain an amount of partial discharge of the heater cable at or below the desirable maximum amount of partial discharge; and
allow no more than an insignificant portion of a return electric current flowing on the inner surface of the heat tube in opposite direction to the alternating current of the conductor to be diverted to the outer semiconductive layer, such that the loss by the heat tube of the insignificant portion does not affect heat output of the heat tube.

3. The skin effect heating system of claim 1, wherein the plurality of ribs extend longitudinally along an entire length of the heater cable.

4. The skin effect heating system of claim 3, wherein the plurality of ribs are uniformly spaced laterally around the heater cable.

5. The skin effect heating system of claim 3, wherein a first rib and a second rib, of the plurality of ribs, each physically contact the inner surface of the heat tube to produce an air gap defined by intersecting surfaces of the first rib, the base layer, the second rib, and the heat tube.

6. A heater cable for use in a ferromagnetic heat tube, the heater cable comprising:
a core conductor that electrically connects at a first end to a source of alternating current, and at a second end to the heat tube;
an electrical insulation layer surrounding the core conductor; and
a semiconductive outer jacket layer surrounding the electrical insulation layer and comprising a base layer and a plurality of ribs extending radially outwardly from the base layer, the outer jacket layer exposed so that, when the heater cable is installed in the heat tube, one or more of the plurality of ribs physically contact an inner surface of the heat tube and space the core conductor away from the inner surface and toward a center of the heat tube.

7. The heater cable of claim 6, wherein the ribs extend longitudinally along an entire length of the heater cable.

8. The heater cable of claim 6, wherein the ribs are uniformly spaced laterally around the heater cable.

9. The heater cable of claim 6, wherein the one or more of the plurality of ribs that physically contact the inner surface of the heat tube produce an air gap between an outer surface of the base layer and the inner surface of the heat tube.

10. The heater cable of claim 6, wherein the base layer and the plurality of ribs are composed of one or more semiconductive materials.

11. The heater cable of claim 10, wherein the plurality of ribs are integral with the base layer.

12. The heater cable of claim 11, wherein the outer jacket layer is extruded over the electrical insulation layer, the base layer being in physical contact with the electrical insulation layer around an entire circumference of the electrical insulation layer.

13. The heater cable of claim 6, further comprising an inner semiconductive layer surrounding the core conductor and surrounded by the electrical insulation layer, the inner semiconductive layer physically contacting the electrical insulation layer around an entire circumference of the inner semiconductive layer.

14. The heater cable of claim 6, wherein when the heater cable is installed in the heat tube, the heater cable physically contacts the inner surface of the heat tube only at a first small area of a first rib of the plurality of ribs and a second small area of a second rib of the plurality of ribs, the second rib adjacent to the first rib.

15. The heater cable of claim 6, wherein:
the electrical insulation layer is associated with an incidence of partial discharge that, when the electrical insulation layer is unshielded and is subjected to a voltage greater than a first rated voltage, exceeds a desirable maximum amount of partial discharge; and
the outer jacket layer shields the electrical insulation layer and has a resistivity that enables the heater cable to, in response to an alternating current being applied to the conductor at an applied voltage exceeding the first rated voltage:
maintain an amount of partial discharge of the heater cable at or below the desirable maximum amount of partial discharge; and
allow no more than an insignificant portion of a return electric current flowing on the inner surface of the heat tube in opposite direction to the alternating current of the conductor to be diverted to the outer jacket layer, such that the loss by the heat tube of the insignificant portion does not affect heat output of the heat tube.

16. The heater cable of claim 15, wherein the electrical insulation layer is perfluoroalkoxy polymer (PFA), the first rated voltage is about 3000 volts, and the applied voltage is between 3500 and 7500 volts, inclusive.

17. The heater cable of claim 16, wherein the outer jacket layer is conductive PFA extruded onto the electrical insulation layer.

18. The heater cable of claim 16, wherein the resistivity of the outer jacket layer is between 5 and 1000 ohm-cm inclusive.

19. The heater cable of claim 15, wherein the electrical insulation layer is silicone, the first rated voltage is about 5000 volts, and the applied voltage is at least 10,000 volts.

20. The heater cable of claim 19, wherein the resistivity of the outer jacket layer is between 0.1 and 10⁵ ohm-cm inclusive.
